(19) United States
(12) Patent Application Publication
(10) Pub. No.: US 2025/0127186 A1
(43) Pub. Date: Apr. 24, 2025

(54) Frosting system

(71) Applicant: Primera Technology, Inc., Plymouth, MN (US)

(72) Inventors: Darren Haas, Minnetonka, MN (US); Erick Theodore Markoberg, Hopkins, MN (US)

(21) Appl. No.: 18/919,077

(22) Filed: Oct. 17, 2024

Related U.S. Application Data
(60) Provisional application No. 63/591,602, filed on Oct. 19, 2023.
(60) Provisional application No. 63/695,746, filed on Sep. 17, 2024.

(51) Int. Cl. A23G 3/34; A23G 3/28

(52) U.S. Cl. CPC A23G 3/343; A23G 3/0063; A23G 3/28

(57) ABSTRACT

A system and method for frosting a plurality of food products with an assembly including using data obtained by a camera and at least one sensor to improve the quality and consistency of automatic frosting of a plurality of food items such as cookies or brownies.

### BACKGROUND

The icing or frosting of a variety of baked goods is a familiar and wide spread practice. In a commercial setting, baked goods such as cookies, brownies and the like are produced and sold in high volume settings such as dedicated bakeries where the items are individually frosted by a baker or assistant and/or in in-store bakeries found in major supermarket chains. In these and other commercial baking establishments, the icing and decorating of baked goods is generally still a manual processes. As such, frosting is generally produced in relatively small batches using standard bakery mixing equipment.

### SUMMARY

An aspect of the present disclosure relates to an assembly for applying frosting to a food product. The assembly includes a main body comprising a nozzle valve block having a nozzle; a food product platform for supporting a food product thereon; a camera; a sensor; a controller configured to receive data from the camera and position sensor and adjust one or more print instructions in response thereto; and one or more frosting cartridges.

The one or more frosting cartridges comprises a plunger and the one or more cartridges are configured to be received by and operably connected to the nozzle valve block.

The nozzle valve block comprises a valve assembly where the nozzle valve block is configured to switch between actuation of the nozzle and a closed position to seal the nozzle.

The assembly comprises a plunger actuator for depressing the plunger and extruding frosting from the frosting cartridge.

The food product platform is movable in each of an X, Y, and Z direction within the assembly.

The camera is configured to capture an image of the food product and the controller is configured to receive data related thereto and correlating to a shape of the food product.

The sensor is configured to sense a distance between a top surface of the food product and the nozzle through which frosting is extruded.

Another aspect of the present disclosure relates to a method of frosting a plurality of food products with an automatic assembly. Frosting the plurality of food products comprises loading a food product onto a platform of an assembly; positioning the platform and food product in a field of view of a camera and collecting data indicative of one or more dimensions of the food product; positioning the platform and food product in a field of view of a sensor and collecting data indicative of one or more dimensions of the food product; positioning the platform and food product below a nozzle of the assembly; using the data indicative of one or more dimensions of the food product to adjust one or more parameters for frosting the food product before and/or while extruding frosting on a top surface of the food product.

The one or more dimensions of the food product comprise a perimeter shape, overall shape, height at one or more locations on the top surface, and combination thereof of the food product.

The one or more parameters include a distance between the top surface of the food product and the nozzle of the assembly.

Loading a frosting cartridge into the assembly and fluidly connecting the frosting cartridge with a nozzle valve of the assembly facilitates frosting or icing the food products. Frosting further includes applying pressure to the frosting cartridge to extrude frosting from the cartridge and through a nozzle of the nozzle valve of the assembly.

To frost the food product the method further comprises rotating a nozzle valve from a closed position to an open position for applying a bead of frosting from the nozzle, the bead of frosting having a first width and being applied around a perimeter or perimeter segment of the food product; and adjusting the pressure applied to the plunger of the frosting cartridge for applying a second bead of frosting of a greater width or applying a second bead of frosting referred to as a “flood” of frosting within the perimeter or perimeter segment of the food product for covering a selected top surface of the food product. Adjusting a height of the platform while extruding the frosting from the nozzle allows for maintaining a predetermined distance between the top surface of the food product and the nozzle before and while extruding the frosting onto the top surface of the food product.

Selecting a pressure for the frosting cartridge may correspond to a viscosity of the frosting in the cartridge and/or bead width of the frosting when extruded and adjusting the pressure allows for maintaining one or more selected qualities of the bead or flood of frosting extruded onto the food product, the qualities comprising a width of the bead. Alternately, the speed of the food product platform may be selected to correspond to a viscosity of the frosting in the cartridge and/or a desired bead width upon extrusion, and adjusting the speed thus may allow for maintaining one or more selected qualities of the bead or flood of frosting extruded onto the food product. The qualities comprise a width of the bead.

The food product described herein is a cookie, biscuit, baked good or the like.

Yet another aspect of the present disclosure relates to a method of calibrating a frosting assembly comprising inserting and fluidly connecting a frosting cartridge to a nozzle block of the frosting assembly; applying a first pressure to a plunger of the frosting cartridge to begin extruding a bead of frosting on to the moveable platform or a food product; and measuring a width of the bead of frosting along the segment of the food product.

In one or more embodiments the method further comprises applying one or more subsequent pressures to the plunger of the frosting cartridge while extruding the bead of frosting along a segment of the moveable platform or food product.

In one or more embodiments, the method further comprises applying one or more subsequent pressures to the plunger of the frosting cartridge and begin extruding one or more subsequent beads of frosting on to the moveable platform or food product.

Increasing the pressure applied to the plunger from the first to each subsequent pressure applied allows for changing a dimension of the bead or one or more subsequent beads of frosting.

Yet another aspect of the present disclosure relates to a method of calibrating a frosting assembly comprising inserting and fluidly connecting a frosting cartridge to a nozzle block of the frosting assembly; setting a first speed of the food product platform to begin extruding a bead of frosting on to the moveable platform or a food product; and measuring a width of the bead of frosting along the segment of the food product.

In one or more embodiments the method further comprises applying one or more subsequent speeds of the food product platform while extruding the bead of frosting along a segment of the moveable platform or food product.

In one or more embodiments, the method further comprises applying one or more subsequent speeds of the food product platform and further to begin extruding one or more subsequent beads of frosting on to the moveable platform or food product.

Increasing or decreasing the speed of the food product platform from the first to each subsequent speed allows for changing a dimension of the bead or one or more subsequent beads of frosting.

Alternatively, a calibration may also occur by extruding a bead of frosting on to the moveable platform or a food product at a defined speed and pressure and measuring the width of the bead of frosting.

Calibrating comprises correlating the measured width with the corresponding pressure and/or speed, and optionally correlating the width of the bead with a viscosity of the frosting; and using the measured bead width and/or corresponding viscosity of the frosting to determine one or more parameters for frosting a food product with the frosting cartridge, wherein the one or more parameters include a distance between a top surface of a food product for frosting and a nozzle. Alternatively, the values related to the measured width may be identified by a pre-calculated model which may correspond to the viscosity of the frosting, either or both of which is used to determine one or more parameters for frosting a food product with the frosting cartridge, wherein the one or more parameters include a distance between a top surface of a food product for frosting and a nozzle, speed of the food product platform and/or pressure for extruding the frosting.

### BRIEF DESCRIPTION OF THE DRAWINGS

FIG. 1 is an isometric view of a system and components for automatically frosting a plurality of food products.

FIG. 2 is an isometric view of the system with a food product positioned for frosting.

FIG. 3 illustrates a stand-alone unit for frosting food products.

FIG. 4 is a front view of the system with a food product positioned for frosting.

FIG. 5 illustrates a camera and height sensor components of the unit.

FIGS. 6A-6B illustrate nozzle valves of the unit.

FIGS. 7-9 illustrate nozzles and valves of the unit.

FIG. 10 illustrates an auto calibrate component of the unit.

### DETAILED DESCRIPTION

A system and method for automatically applying an edible food layer to one or more pre-prepared food product(s) is described herein. The assembly and system described herein is configured to apply an edible layer(s), decoration or the like to a top surface of the food product(s). In the embodiment illustrated, the assembly is configured for applying or otherwise depositing frosting or icing on a pre-prepared food product such as a cookie.

The assembly generally comprises a food product platform for positioning the food product, such as a cookie or the like, during printing and a frosting reservoir having an extrusion nozzle, allowing for the continuous frosting of one or more food items. The term “frosting” may be used throughout this disclosure to refer to the applying of the edible food layer and the composition of the edible food layer itself, however it should be understood that the term “frosting” may be used interchangeably with the term “icing” to refer to the application and/or the composition of the edible food layer applied to the food product. The embodiments described herein are not limited to frosting compositions and include icing and other edible food layers having varying viscosities and compositions.

The assembly described herein may further comprise one or more cameras, sensors, or combinations thereof as the system is configured to determine one or more features of the food product. The feature(s) are used to position the platform and/or extrusion nozzle for consistent and precise application of frosting on a surface of the food product. The positions of the food product, platform and/or extrusion nozzle may be adjusted for each food product printed thereon, before and/or during frosting application. Further, the system comprises a controller which utilizes one or more print files and/or instructions, alone and/or in combination with data from the one or more cameras and/or sensors to evenly apply a selected quantity of frosting to the food product.

The assembly receives one or more commands and/or instructions via a controller which enable the assembly to apply a perimeter bead of frosting along a frosting path. The frosting path may substantially match a perimeter of the food product or may take a shape and location on the food product according to a print instruction received by the assembly. The assembly is then further configured to fill in a selected surface area within the frosting path with a flood of frosting. The flood of frosting may be a bead of frosting having a larger width. Thus, the assembly may be configured to switch between frosting amounts to be deposited on the food product while applying the frosting to one or more locations on and/or along one or more frosting paths on the food product according to received print instructions.

In one embodiment, the system has a single nozzle used for extruding frosting in beads at a plurality of varying widths, that is the same nozzle is used for a perimeter, thin bead, of frosting and an interior, flood bead of frosting. The bead width is adjusted by way of varying pressures for extruding the frosting through the nozzle, the speed of movement of the food product on a food product platform, or combinations thereof. Alternatively, the system can be provided with two nozzles, a bead nozzle and a flood nozzle where the system switches between nozzles for frosting a food product while applying the frosting to one or more locations and/or along one or more frosting paths according to received print instructions. The system may be utilized for frosting a food product using frosting beads of varying widths, however, the system is also configured to apply frosting on a partial and/or entire food surface using a bead of a consistent width and/or size if desired.

Moreover, the speed of the movement of the platform holding the food product and/or pressure in the frosting cartridge determinations and variations may also take into account a viscosity of the frosting or a bead width of the frosting, such that calibration and operation of the system according to one or more embodiments described herein may allow the system to apply frosting sufficient to cover the selected surface of the food product without frosting drippage or migration off of the selected surface (for example, down a side of the food product) and without rippling of the frosting such that a substantially flat and smooth application of frosting is applied where selected. This holds true for food products of irregular perimeter shapes as well for food products with inconsistent and/or rough surface topography.

The assembly is further configured to adjust a vertical position between a top surface of the food product, the top surface referring to the surface of the food product facing the frosting nozzle and thus being the surface to be frosted. The assembly utilizes data received from a camera and one or more sensors such as a position and height sensor to adjust the distance between the top surface of the food product and the nozzle to maintain a pre-set distance between the nozzle and the top surface of the food product. Adjustment of the food product vertical position may be done before and/or continuously during a frosting application to substantially maintain or otherwise maintain the pre-set distance continuously while frosting. Such adjustment accounts for irregular or rough surface topography for sufficient and clean frosting application in selected locations on the food product, which may include an entire top surface area or portions thereof.

The assembly further is configured to adjust a pressure within the frosting cartridge via adjustment of the movement and/or position of the plunger for moving the frosting through the nozzle of the cartridge. The pressure may be adjusted based on a viscosity of the frosting batch in the cartridge and can be adjusted before, between and/or during frosting applications to apply a bead or flood of frosting to have continuous particular pre-selected qualities such as bead width or flood amount and/or a pre-selected quality or appearance based on viscosity of the specific batch. For example, pressure may be set prior to calibration of the system before frosting one or more food items. The pressure may be pre-selected and one or more beads of frosting at two or more different pressures extruded. Calibration further comprises measuring the observed frosting bead width at each pressure for extrusion. By way of non-limiting example, the system allows for pressure for extruding the frosting through the nozzle of the cartridge to range from about 40 lbs of force for a frosting outline (e.g., thinner bead of frosting) to about 80 lbs of force for a flood coat (e.g., coverage or surface filling) or more, for example up to about 105 lbs of force.

The assembly may be further configured to adjust the speed of the food product platform to also account for and/or adjust the size of the extruded frosting bead. The speed may be adjusted based on a viscosity of the frosting batch in the cartridge and can be adjusted before, between and/or during frosting applications to apply a bead or flood of frosting having continuous particular pre-set qualities such as bead width or flood amount and/or a pre-selected quality or appearance based on viscosity of the specific batch.

The assembly may be further configured to determine the location of the nozzle tip and utilize camera pixel information for precision determination of the location of the nozzle tip, with for example, respect to the food product platform and/or food product itself. A food product object image is captured by the camera and a map generated of the camera pixels vs. a location of the nozzle tip with respect thereto. A calibration on each machine may be performed to carry out nozzle tip to camera mapping.

While the above methods for adjusting the size of the extruded frosting bead may be described in connection with a single nozzle size, the system may be provided with various interchangeable nozzles with outlets of varying sizes.

The assembly is configured for applying an edible finish to a food product. In the embodiment illustrated in the figures, the edible finish is a frosting. The frosting may be a royal icing, a butter cream type and consistency, a whipped frosting or gel or other edible finishing materials generally referred to as “frosting” for pastries, cakes, cookies and the like. The food product illustrated herein comprises cookies but may further include brownies, cakes, pastries or other food products.

The system can be calibrated using one or more methods. For example, the system can be calibrated with respect to the width of the bead of frosting to be extruded from a nozzle using multiple pressures for the frosting cartridge, multiple speeds of movement of the food product platform, or combinations thereof and which accounts for the viscosity of the frosting in the cartridge being used,. One or more beads of frosting are laid down and widths of the one or more beads are measured using the camera. The camera measures the widths at one or more locations and that correspond to different pressures (such as downward plunger pressure) in the cartridge, different speeds of movement of the platform, or combinations thereof. The measured width informs the software which provides a determination of how far apart to space a first frosting path from second and subsequent frosting paths on a surface of a food product. For example, the spacing between a perimeter bead and the one or more wider beads of frosting laid down along a second, third and/or subsequent paths is determined so as to substantially cover the food product surfaces in a consistent and even coat of frosting. The spacing also is calculated in order to provide sufficient and/or selected coverage for the food product and varies based on frosting bead width for example.

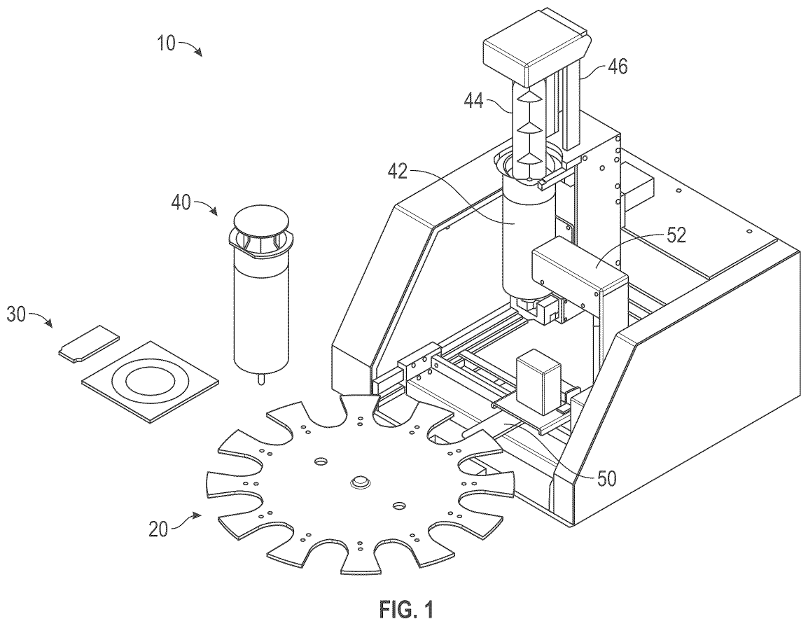

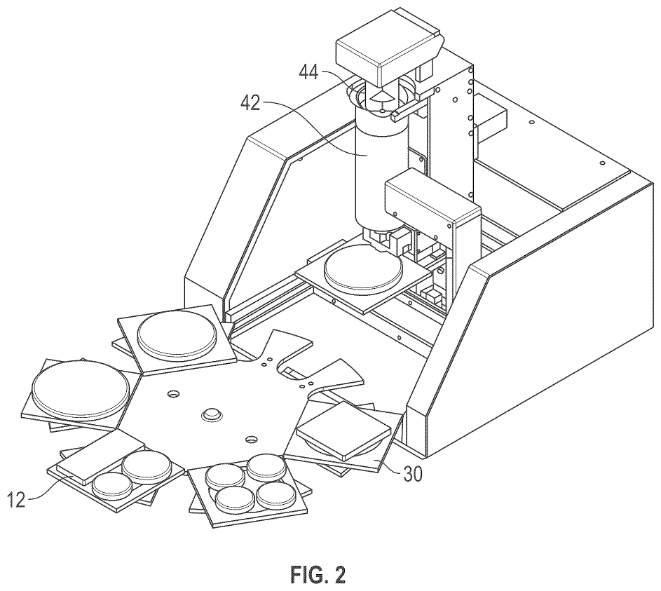

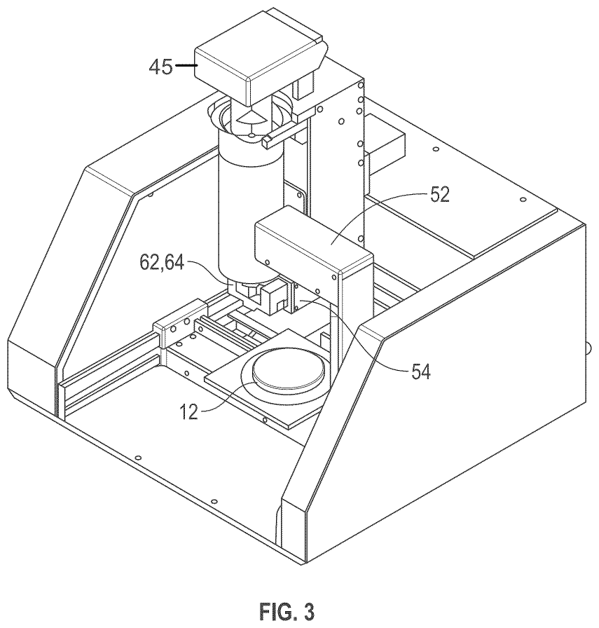

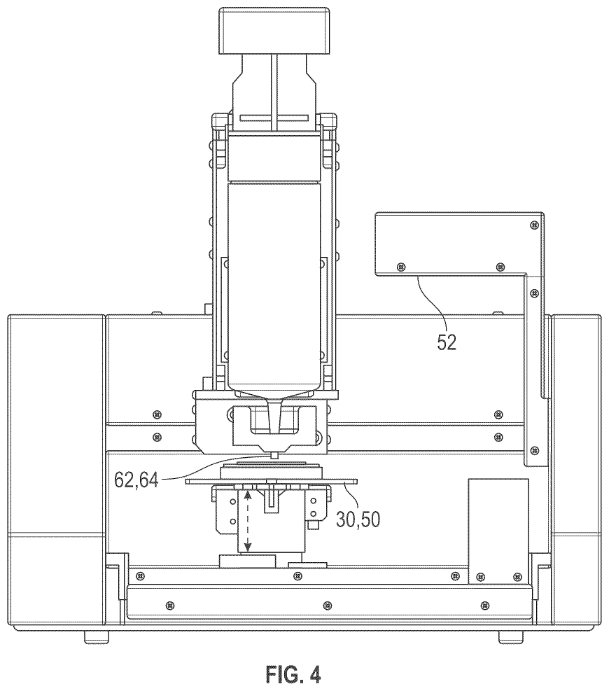

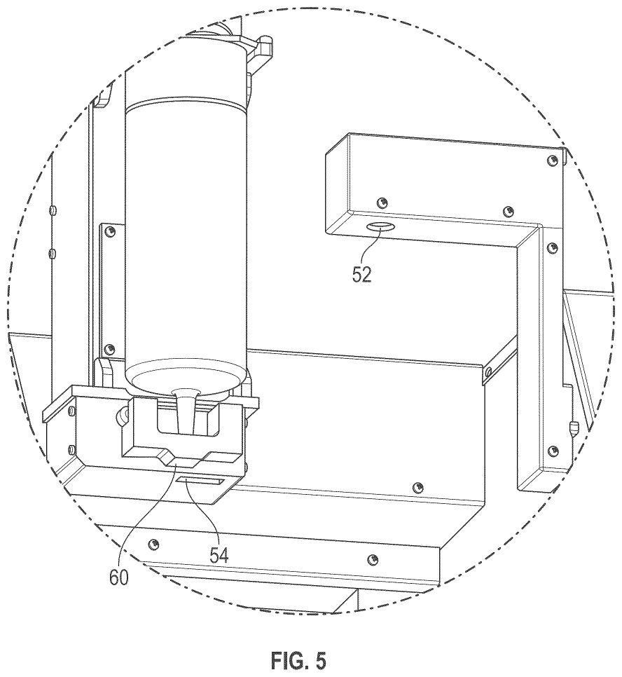

A system for frosting a plurality of food products is illustrated generally in the figures. FIGS. 1-3 illustrate the frosting or icing system which includes an assembly 10, a carousel 20 for delivery of a plurality of food products 12, an optional removable food product platform 30, and a frosting cartridge 40. The printing assembly 10 configured for frosting the food product operably receives the frosting cartridge 40 which comprises a frosting cartridge body 42 and a plunger 44. The printing assembly 10 comprises a plunger activator 46 for extruding the frosting through a nozzle of the frosting cartridge 40. A force gauge and transducer (not shown) is provided above the plunger 44, for example, below a cover 45 for the area accepting the frosting cartridge 40 and which monitors and/or controls the downward pressure and/or position of the plunger 44 along the height of the cartridge body 42. The printing assembly 10 further comprises a movable support platform 50 for holding a food product 12 during the frosting process, a camera 52, and one or more sensors 54 for measuring one or more height features of the food product 12 on the movable support platform 50. A purge station (not shown) and/or nozzle cleaning station may also be provided in the system. In the embodiment illustrated the purge station comprises a wiper for cleaning frosting off the nozzle before said frosting can dry or clog the nozzle. The purge station is positioned behind the gantry and/or behind a frosting window below the cartridge 40 of the system. That is, the purge station is in the back of the system but may be provided in any location for access to the nozzle and/or frosting cartridge.

In the embodiment illustrated the frosting cartridge 40 is a 500 mL tube and a outlet of the nozzle thereof has a 1.5 mm orifice, however, it is contemplated and within the scope of this disclosure that a cartridge 40 of greater than or less than 500 mL can be used in substantially the same manner as described herein and with a nozzle having an outlet of 1.5 mm, or an outlet less than 1.5 mm or an outlet greater than 1.5 mm.

The printing assembly 10 comprises a nozzle sealing mechanism, such as a nozzle valve for closing off the nozzle between frosting applications and/or to close off the cartridge 40 when not in use to prevent the frosting from drying out. In one embodiment, the nozzle assembly 60 and nozzle valve include a single nozzle 62 for frosting. In other embodiments, the nozzle assembly 60 and nozzle valve provides two nozzles 62, 64 for frosting. Where two nozzles 62, 64 are provided, a first nozzle 62 is a smaller nozzle configured for providing a perimeter “bead” of frosting and a second nozzle 64 is a larger nozzle configured for applying a filling of frosting, also referred to as a “flood” nozzle for frosting. Where a single nozzle is utilized and as illustrated, the nozzle 62 is used for providing both a perimeter bead of frosting and providing a flood of frosting as controlled and adjusted by the pressure in the frosting cartridge, movement of the plunger, and/or by the speed of the platform supporting the food product thereon.

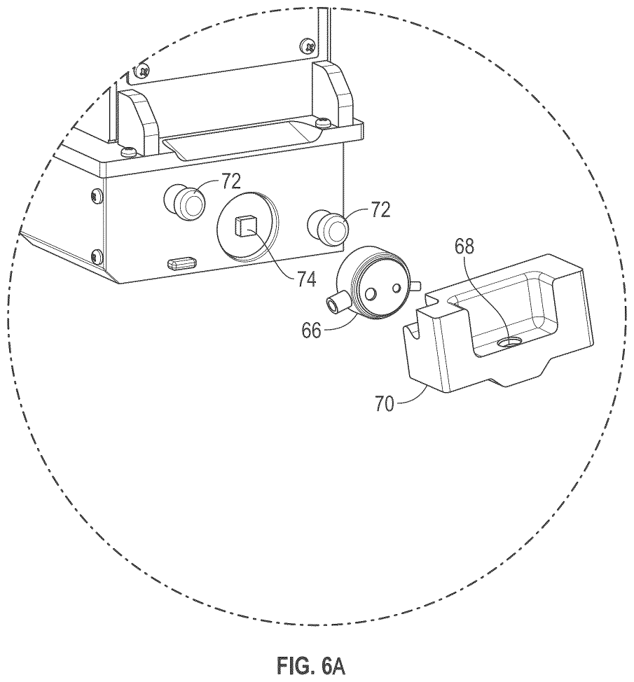

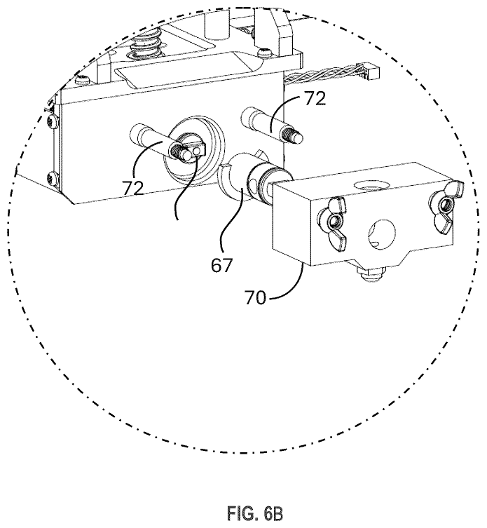

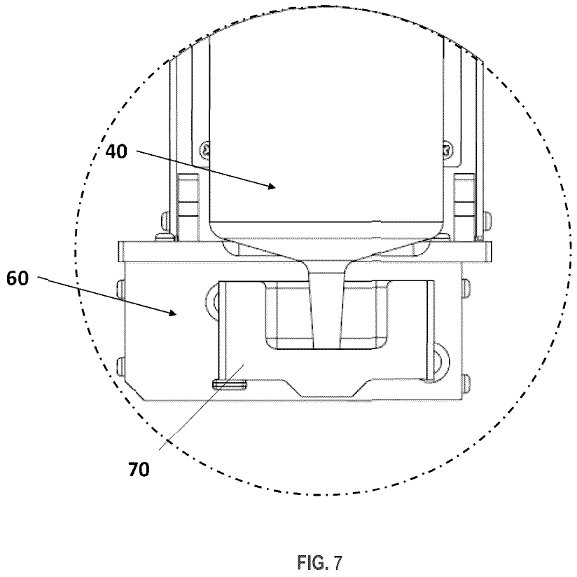

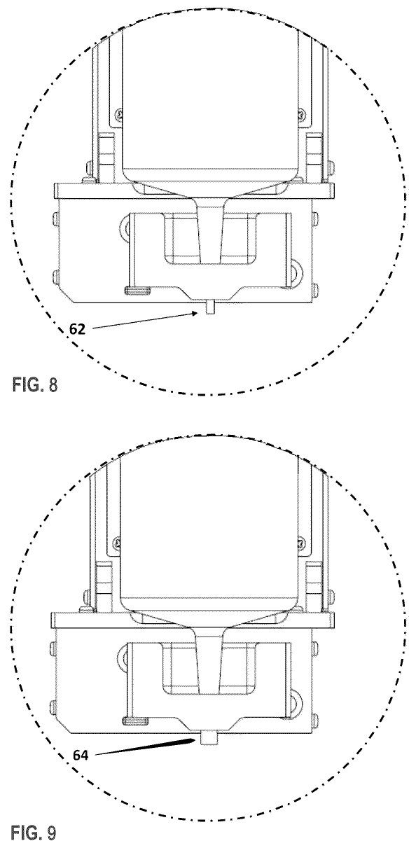

As shown in further detail in FIGS. 6A-9, in one embodiment the nozzle assembly 60 comprises a rotating valve core 66 with a valve block 70, both of which may be removable for cleaning or maintenance. The rotating valve core 66 provides the nozzle 62 (and in some embodiments also nozzle 64) and controls whether the outlet of the nozzle 62 (and/or nozzle 64) is aligned with an aperture 68 in the valve block 70 for extrusion. The rotating valve core 66 can be rotated to close or block off the aperture 68 between frosting operations and thus cover nozzle 62 so as to prevent drying out of the frosting in the fluidly connected cartridge. The core 66 and block 70 are removably secured via locking posts 72 to an assembly which couples the frosting cartridge 40 operably to the nozzle(s) 62 (64) inside the printing system 10, which supports a valve drive assembly 74 and a locking mechanism 72 for securing the valve core 66 and block 70 thereto. It is contemplated and within the scope of this disclosure that the nozzle assembly may comprise a valve other than the rotating valve described above. For example, as shown in FIG. 6B, a gate type valve or other bidirectional (linear) valve mechanism 67 may be used for opening and closing the nozzle 62 where the valve block 70 is removably secured via locking posts 72 to an assembly which couples the frosting cartridge 40 operably to the nozzle 62 which may be an interchangeable nozzle 62. A valve drive assembly 75 and the locking mechanism 72 are provided for securing the valve mechanism 67 and block 70 thereto for operation.

The system 10 further comprises a controller which is in wired or wireless communication with a computer or software allowing a user to send print commands and/or instructions to the assembly 10. A control panel on the printing system 10 also allows for manual input and/or direct control of one or more operations of the system including a power on/off and other basic functions of the system and other settings.

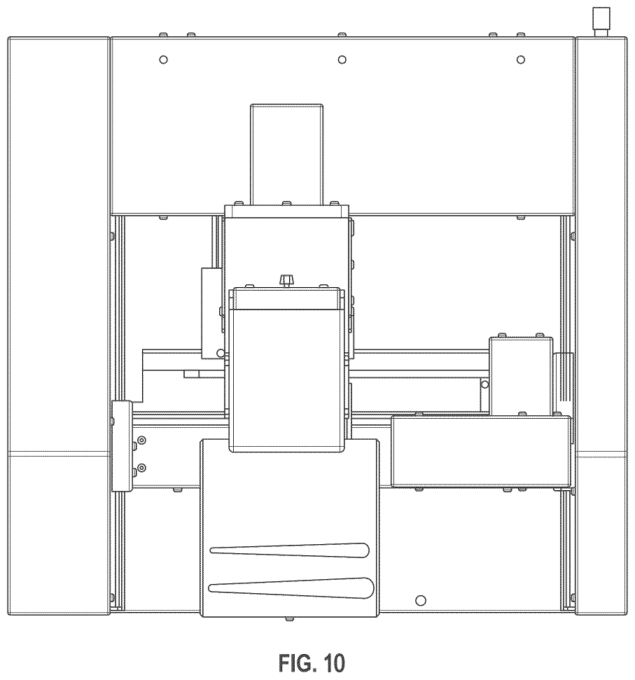

In FIG. 10, calibration of the printing system 10 is described. Calibration of the machine includes calibrating one or more machine settings as relate to a viscosity of a batch of frosting loaded into the frosting cartridge 40. Calibration includes the application of at least one bead of frosting, such as a thin bead of frosting using the nozzle 62 while moving the food product platform. The frosting is applied directly to the support platform or to a food product in one or more beads with varying pressure and/or speed. For example, frosting is initiated at a low pressure in the frosting cartridge for extruding the frosting as a bead. The pressure and/or downward force or speed of the plunger may or may not be increased slowly while extruding the bead of frosting, and/or multiple beads of frosting may be deposited at different pressures and/or downward force or speed of the plunger. This results in at least one frosting bead along a length of the support platform or food product, where in one embodiment the frosting bead may or may not have a first end that has a smaller dimension such as a width due to the lower frosting pressure in the cartridge and the second end of the bead having a larger dimension, such as a width, due to the increased frosting pressure in the cartridge. Alternatively, multiple individual beads or lines of frosting may be deposited and compared as each bead or line represents a set pressure and speed. Alternatively, frosting is initiated at an initial speed for extruding the frosting as a bead. The speed of the support platform may be decreased slowly while extruding the bead of frosting. This results in a frosting bead along a length of the support platform or food product, the frosting bead having a first end that has a smaller dimension such as a width due to the higher speed and the second end of the bead having a larger dimension, such as a width, due to the decreased speed of the support platform. The camera in the system measures the width of the bead at various pressure and/or speed settings whether those settings are on one line bead of frosting or across a plurality of lines or beads of frosting. These measured widths may be compared to known values of bead width relative to frosting viscosity and/or otherwise used to determine adjustments to the pressure in the frosting cartridge and/or the speed of the support platform when frosting food products to maintain a constant selected bead width for example.

Additionally, or alternately, the camera in the system may measure the width of a frosting bead created at a certain speed and pressure. This measured width may be compared to known values of bead width relative to frosting viscosity or may otherwise be used for real time determinations and calculation which allow for adjusting the pressure in the frosting cartridge and/or the speed of the support platform when frosting food products to maintain a constant selected bead width for example.

Additionally, or alternatively, the software can be used to select a speed and pressure during the frosting application, and the previously measured calibration width will inform the software how far apart to space a first and subsequent beads of frosting to provide sufficient or selected coverage to the food product surface.

Once the calibration step has been carried out, one or more food products may be frosted. The calibration may be carried out one or more times for each frosting cartridge and/or batch of food products. The bead(s) of frosting may be applied to cover and/or coat the food product in frosting in a circular or spiral path for frosting, although other paths are contemplated and within the scope of this disclosure. As a non-limiting example, the frosting is applied in a spiral path where the spacing between beads or passes of frosting is calculated during calibration and is determined in a manner that substantially covers the surface area of the food item in a smooth and flat manner without rippling and/or over application. That is, the cookie is frosted in a manner where a sufficient amount of frosting, without excess, covers the surface area of the food product intended for frosting. Frosting spread as well as nozzle “on” time and “off time” are accounted for such that the frosting does not overlap or clump or leave unintentionally unfrosted areas on the food product.

The system may be operated manually or automatically to apply frosting on one or more food products continuously and sequentially.

In one embodiment, a user places a food item on the platform and frosting or icing is controlled and/or adjusted based on data received from the camera and/or sensors and/or in combination with additional user inputs and other parameters including for example offsets, speed and the like. Actuation of the system includes selected, such as pressing, a “Load/Unload” button on the system to begin the operation. The platform is moveable in the x, y, and z directions. The system moves the platform below or in the line of sight of a height sensor to obtain an overall height of the food product. During frosting, the height of the platform is adjusted to maintain a pre-selected distance between the nozzle and the surface of the food product being frosted. Variation outside an acceptable range of pre-selected distance can result in clogging the nozzle if the surface of the food product is too close to the nozzle or an uncontrolled (e.g., wavy or squiggled) stream or length of frosting exiting the nozzle before the frosting contacts the food product resulting in frosting displacement or misplacement and mess if the surface of the food product is too far away from the nozzle. Such variations may result in inconsistent application of frosting if the nozzle was vertically spaced too far from the top surface of the food product. After sensing the height and topography of the food product, the system moves the platform to a position under or in the line of sight of a camera. When calibrating and when frosting a food product, the camera first captures one or more images of the food product and is capable of distinguishing between the food product and the background (e.g., platform surface) such that the perimeter shape of the food product is known. This allows the system to frost food products that are not circular or square but have irregular perimeter shapes. The system then automatically adjusts a position of the platform, such as a vertical position, so that a top surface of the product is a set distance from the camera before and during frosting. For example, the distance between the camera and the top surface of the food product is maintained at a threshold setting and thus the position of the platform is adjusted to ensure this distance is attained. An image of the top of the food product is taken, and data therefrom is processed to create an outline image of the food product for determining the frosting path(s) to cover the food product.

The system moves the platform back to a position under the height sensor and traces an entire outline of the food product according to the outline image of the food product. Thus the system determines the height of the food product all the way around an outer edge of the food product. This data is used to adjust the position (vertical) of the food product, such as a cookie, relative to the vertical position of the nozzle, so the vertical distance between the top surface of the food product and the nozzle remains constant at a selected distance regardless of changes in thickness of the food product or vertical positions of the top surface of the food product (e.g., non-flat food products). The distance between the nozzle and the top surface of the food product at the extrusion location is always the same distance. Thus, the platform and/or the nozzle may be vertically adjusted before and/or during frosting the food product to maintain a set distance between the food product surface directly below the nozzle. This allows for a constant diameter and consistency of the frosting bead to be deposited and allows for uniform quality of an outer perimeter bead and accurate placement of the bead on the food product. The food product may be positioned at a determined start/stop point when the outer frosting bead is to be applied.

For application of frosting, the system applies pressure to a frosting cartridge by depressing a plunger. A force gauge measures the amount of pressure being applied to the frosting cartridge plunger. Once a selected or acceptable pressure is obtained, the valve will open the nozzle and the assembly will begin tracing the outline path by moving the platform in an x, y, z direction and combinations thereof using the data received from the camera and the distance sensor. Once an end of the outline path is reached, the nozzle valve may close off the nozzle, and the assembly may move the platform to a determined start point for a second application, which is a flood coat. The assembly will then fill the entire inner area of the food product inside the outer bead by tracing an offset path from the outer bead and spiraling inwards until the entire food product is frosted. The flood coat may be achieved by increasing the pressure applied to the frosting cartridge with respect to the pressure applied to the frosting cartridge when tracing the outline path for the bead of frosting. It is during the movement of the nozzle along the second inner path for frosting the food product that the pressure and/or the speed of the movement of the platform is adjusted to provide the flood of frosting or bead of frosting having an increased width. The nozzle valve may then be rotated to turn the nozzle to the off position and the system returns the platform to the load/unload position at the front of the assembly.

Optionally, the assembly system may cooperate with a feeding accessory to automatically apply frosting to a plurality of food products. In such embodiments, a user places up to six food items on up to six platforms spaced equally around and supported on a carousel tray, or alternatively up to twelve food products directly onto the carousel tray itself and then sends a print file to the assembly. The system will automatically lift a food product off the carousel tray and load the food product on to the platform, proceeding to apply frosting to the food product in the manner described previously above in manual mode. Once the food product has been frosted, the machine will return the completed food item to the carousel tray, move back out of the way while the carousel moves to the next position, and then lift the next food product to continue the process. A software selection by the user will tell the machine whether six positions (with platforms) or twelve positions are loaded with food products.

The systems and methods described herein may also be used for precision frosting, or otherwise decorating food products. While described herein is a system of applying frosting to substantially an entire top surface of the food product or a selected portion thereof, it is also contemplated that the methods described herein can be used for frosting designs, writing text, and otherwise drawing on the food product in a manner where portions of the food product remain unfrosted.

Although the present disclosure has been described with reference to preferred embodiments, workers skilled in the art will recognize that changes may be made in form and detail without departing from the spirit and scope of the disclosure.

Claims:

1. An assembly for applying frosting or icing to a food product, the assembly comprising;
a nozzle valve block supporting a nozzle;
a food product platform for supporting a food product thereon;
a camera;
a position sensor;
a pressure sensor;
a controller configured to receive data from the camera and position sensor and adjust one or more print instructions in response thereto; and
one or more frosting cartridges.

2. The assembly of claim 1 wherein the one or more frosting cartridges comprises a plunger and the one or more cartridges are configured to be received by and operably connected to the nozzle valve block.

3. The assembly of claim 1 wherein the nozzle valve block comprises a valve assembly configured to switch between actuation of the nozzle and a closed position to seal the nozzle.

4. The assembly of claim 2 wherein the assembly comprises a plunger actuator for depressing the plunger and extruding frosting from the frosting cartridge.

5. The assembly of claim 1 wherein the food product platform is movable in each of an X, Y, and Z direction within the assembly.

6. The assembly of claim 1 wherein the camera is configured to capture an image of the food product and the controller is configured to receive data related thereto and correlating to a shape of the food product.

7. The assembly of claim 1 wherein the position sensor is a height sensor configured to sense a distance between a top surface of the food product and the nozzle through which frosting is extruded at one or more locations on the food product.

8. A method of frosting a plurality of food products, the method comprising:
loading a food product onto a platform of a frosting assembly;
positioning the platform and food product in a field of view of a camera and collecting data indicative of one or more dimensions of the food product;
positioning the platform and food product in a field of view of a sensor and collecting data indicative of one or more dimensions of the food product;
positioning the platform and food product below a nozzle of the assembly;
determining a frosting path for laying down one or more beads of frosting on the food product; and
using the data indicative of one or more dimensions of the food product to adjust one or more parameters for frosting the food product along one or more segments of the frosting path before and/or concurrently with extruding frosting on a top surface of the food product along the one or more segments of the frosting path.

9. The method of claim 8 wherein the one or more dimensions of the food product comprise a perimeter shape, overall shape, height at one or more locations on the top surface, and combination thereof of the food product.

10. The method of claim 8 wherein the one or more parameters include a distance between the top surface of the food product and the nozzle of the assembly.

11. The method of claim 8 and further comprising loading a frosting cartridge into the assembly and fluidly connecting the frosting cartridge with a nozzle valve of the assembly; and applying pressure to the frosting cartridge to extrude frosting from the cartridge and through the nozzle of the nozzle valve of the assembly.

12. The method of claim 8 wherein the frosting path comprises at least one outer and least one inner path segment and wherein a spacing between adjacent path segments is determined based on a speed of movement of the platform supporting the food product, a pressure in a frosting cartridge for extruding the frosting through the nozzle, a viscosity of the frosting, and combinations thereof.

13. The method of claim 11 and further comprising:
moving a nozzle valve from a closed position to open the nozzle for applying a first bead of frosting around a perimeter or perimeter segment of the food product; and
increasing pressure in the frosting cartridge to apply a second bead of frosting within the perimeter or perimeter segment of the food product,
wherein the second bead has a width greater than the first bead and such that the first bead and the second bead cover a surface of the food product.

14. The method of claim 8 and further comprising adjusting a height of the platform while extruding the frosting from the nozzle to maintain a predetermined distance between the top surface of the food product and the nozzle before and while extruding the frosting onto the top surface of the food product.

15. The method of claim 12 and further comprising selecting a pressure for the frosting cartridge that corresponds to a viscosity of the frosting in the cartridge and adjusting the pressure to maintain one or more selected qualities of the bead of frosting extruded onto the food product, the qualities comprising a width of the bead.

16. The method of claim 8 wherein the food product is a cookie.

17. A method of calibrating a frosting assembly comprising:
inserting and fluidly connecting a frosting cartridge to a nozzle block of the frosting assembly;
selecting a parameter to adjust wherein the parameter adjusting comprises at least one of:
applying a first pressure to a plunger of the frosting cartridge to begin extruding a bead of frosting on to a food product and applying one or more subsequent pressures to the plunger of the frosting cartridge while extruding the bead of frosting or while extruding a second bead of frosting along one or more locations on the food product; or
moving a food product platform at a first speed while extruding a bead of frosting on to a food product on the food product platform and increasing or decreasing a speed of the food product platform while extruding the bead of frosting or while extruding a second bead of frosting along a segment of the food product; and
measuring a width of the bead of frosting or the second bead of frosting at one or more locations on the food product.

18. The method of claim 17 and further comprising increasing the pressure applied to the plunger from the first to each subsequent pressure applied.

19. The method of claim 17 and further comprising correlating the measured width with the corresponding pressure for the frosting cartridge for determining a frosting path for frosting a food product with the frosting cartridge.

20. The method of claim 19 and obtaining an image of the food product for determining a perimeter shape of the food product and obtaining topography measurements of a top surface of the food product for selecting one or more parameters for frosting a food product with the frosting cartridge including a distance between a top surface of a food product for frosting and a nozzle during frosting, a path for extruding the frosting on the food product, a spacing between adjacent segments of frosting along the frosting path, and combinations thereof.

21. The method of claim 17 and further comprising correlating the measured width with the selected speed of moving the platform, the selected pressure applied to the plunger of the frosting cartridge or combinations thereof for selecting one or more parameters for frosting a food product with the frosting cartridge including a path for extruding the frosting on the food product, a spacing between adjacent segments of frosting along the frosting path, and combinations thereof.

22. The method of claim 21 and further determining one or more parameters for frosting a food product with the frosting cartridge, wherein the one or more parameters include a speed of the moving platform, a pressure applied to the plunger, a height of the moving platform, or combination thereof before and/or during frosting of the food product.

23. The method of claim 20 and further comprising using camera pixels from the image of the food product to determine an exact location of a tip of the nozzle with respect to the food product.
